(19) United States
(12) Patent Application Publication
(10) Pub. No.: US 2009/0248633 A1
(43) Pub. Date: Oct. 1, 2009

(54) SYSTEM AND METHOD FOR DIRECT DISPLAY OF COUPONS WITHIN SEARCH RESULT SETS

(76) Inventor: Erik Ojakaar, San Jose, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(21) Appl. No.: 12/060,120

(22) Filed: Mar. 31, 2008

(51) Int. Cl. G06F 17/30

(52) U.S. Cl. 707/3; 707/E17.108

(57) ABSTRACT

Embodiments of the present invention provide methods, systems and computer program products for the direct display of coupons within a search result set. The present invention includes receiving a search query comprising one or more terms from a user and parsing the search query into one or more constituent terms. A predetermined constituent term is then identified. One or more coupons responsive to the search query are then identified and displayed to the user in a result set. The identification of the one or more coupons responsive to the search query can be accomplished by searching a coupon data store using the parsed search query, wherein the coupon data store comprises an index of one or more coupons, by searching one or more content sources provided by one or more content providers over a network using the parsed search query, or a combination of both.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to retrieving coupons online. More specifically, the present invention provides systems, methods and computer program products for the direct display of coupons within a search result set.

### BACKGROUND OF THE INVENTION

A coupon is a document that can be exchanged for a financial discount or rebate when purchasing a product. Typically, coupons are issued by manufacturers of consumer packaged goods or by retailers for use in retail stores as a part of sales promotions. With the recent explosion of good and services available through the Internet, coupons have become increasingly available in this digital environment, allowing for retailers and manufacturers to avoid postal and copying costs and granting consumer users access to a large library of coupon documents. It is well known in the art that Internet search engines are the primary resource used to find coupons, both for online purchase and in-store purchases for everything from restaurants to digital cameras to hotels.

Current techniques for searching for coupons on the World Wide Web allow for the return of a conventional result set that encompasses hypertext links to websites that host coupons that match the query. However, such techniques resulted in the user exerting additional time to access such coupons. Furthermore, by solely providing a result set of hypertext links, users are vulnerable to the common problem of hypertext links containing false leads, that is hypertext links to websites that in fact do not host the coupon as was indicated in the result set, resulting in frustrated users. Therefore, there exists a need for systems, methods and computer program products that provide for the direct display of coupon images within a search result set.

### SUMMARY OF THE INVENTION

Generally, the present invention provides for methods, systems and computer program products for the direct display of coupons within a search result set. The present invention includes receiving a search query comprising one or more terms from a user and parsing the search query into one or more constituent terms. A predetermined constituent term is then identified. One or more coupons responsive to the search query are then identified and displayed to the user in a result set. The identification of the one or more coupons responsive to the search query can be accomplished by searching a coupon data store using the parsed search query, wherein the coupon data store comprises an index of one or more coupons, by searching one or more content sources provided by one or more content providers over a network using the parsed search query, or a combination of both.

In providing for the for the direct display of coupons within a search result set, the present invention allows for the solution to frustrated users to the common problem of hypertext links containing false leads by allowing the users to immediately see coupons responsive to their search query within the result set, saving users both frustration and time.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of a system displaying coupons directly within search results according to one embodiment of the present invention;

FIG. 2 illustrates a flow diagram presenting a method for displaying coupons directly within search results according to one embodiment of the present invention;

FIG. 3 illustrates a flow diagram presenting a method for searching a coupon index in order to display coupons directly within search results according to one embodiment of the present invention;

FIG. 4 illustrates a flow diagram presenting a method for searching content sources in order to display coupons directly within search results according to another embodiment of the present invention;

FIG. 5 illustrates a flow diagram presenting a method for searching content sources and a coupon index in order to display coupons directly within search results according to another embodiment of the present invention; and

FIG. 6 illustrates a sample screen image of a result set which display coupon images directly within the result set according to one embodiment of the present invention.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

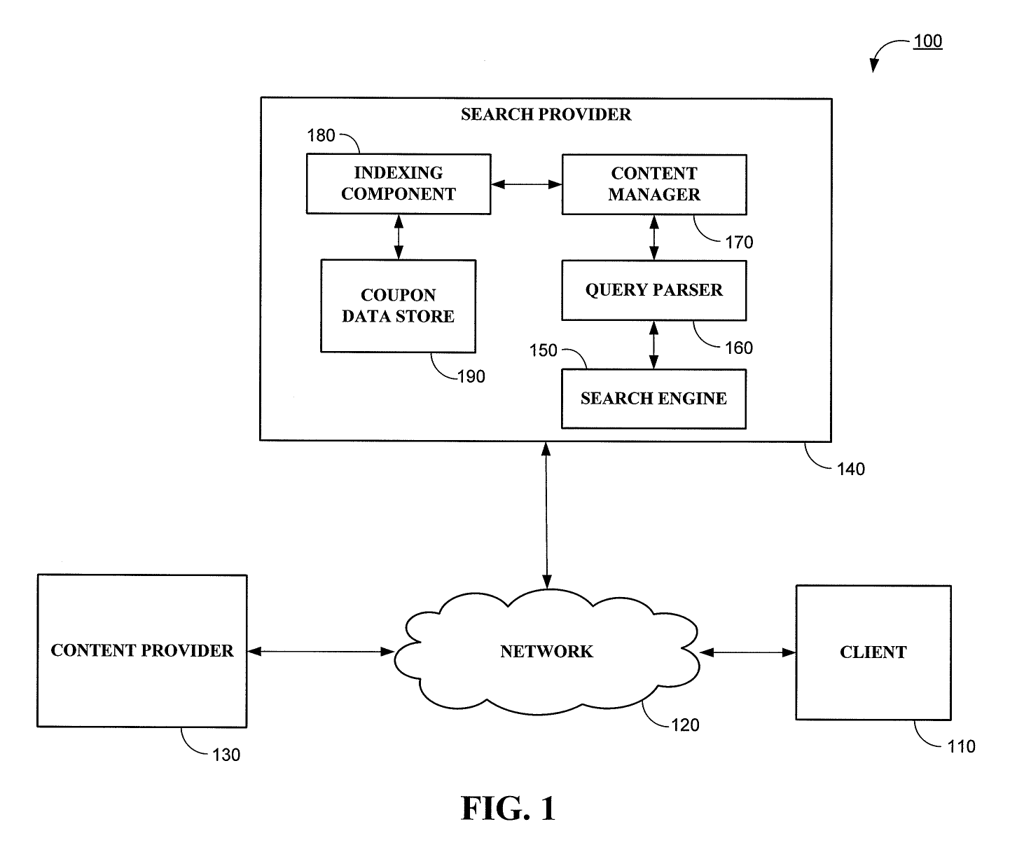

FIG. 1 illustrates one embodiment of a system for displaying coupons directly within search results 100 that includes one or more clients 110, a computer network 120, a content provider 130, and a search provider 140. The search provider 140 comprises a search engine 150, a query parser 160, a content manager 170, an indexing component 180 and a coupon index 190.

The computer network 120 may be any type of computerized network capable of transferring data, such as the Internet. According to one embodiment of the invention, a given client device 110 is a general purpose personal computer comprising a processor, transient and persistent storage devices, input/output subsystem and bus to provide a communications path between components comprising the general purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc. The present invention is not limited to only a single client device 110 and may comprise additional, disparate client devices. The client device 110 is therefore presented for illustrative purposes representative of multiple client devices.

According to one embodiment of the invention, the content provider 130 and the search provider 140 are programmable processor-based computer devices that include persistent and transient memory, as well as one or more network connection ports and associated hardware for transmitting and receiving data on the network 120. The content provider 130 and the search provider 140 may host websites, store data, serve ads, etc. Those of skill in the art understand that any number and type of content provider 130, search provider 140 and client device 110 may be connected to the network 120.

The search engine 150, the query parser 160, the content manager 170 and the indexing component 180 may comprise one or more processing elements operative to perform processing operations in response to executable instructions, collectively as a single element or as various processing modules, which may be physically or logically disparate elements. The coupon data store 190 may be one or more data storage devices of any suitable type, operative to store corresponding data therein. Those of skill in the art recognize that the search provider 140 may utilize more or fewer components and data stores, which may be local or remote with regard to a given component or data store.

In accordance with one embodiment, the client device 110, the search provider 140 and the content provider 130 are communicatively coupled to the computer network 120. The client device 110 communicates across the network 120 with the search provider 140 and may transmit one or more search queries which may comprise one or more terms. The search engine 150 of the search provider 140 receives the search query and delivers the search query to the query parser 160. The query parser 160 parses the query and delivers the parsed terms to the content manager 170, which makes a determination as to whether the search query contains a request for a coupon.

The term coupon is used throughout this application to refer to a document, which can be in either a printable or an electronic format, which can be exchanged for a financial discount or rebate when purchasing a product. A coupon may incorporate a special code, UPC symbol, etc. to be utilized by a merchant in order to authenticate the financial discount or rebate.

According to one embodiment, the content manager may generate a search request to the indexing component 180 based upon the parsed search query to identify one or more coupons responsive to the search query. The indexing component 180 may then perform a search of the coupon data store 190 in order to locate one or more coupons responsive to the search request generated by the content manager 170. The indexing component 180 then retrieves the one or more coupons and passes the one or more coupons to the content manager 170, which communicates with the client device 110 over the computer network 120 to return a result set of the one or more coupons responsive to the search query, which is displayed at the client device 110 to a user.

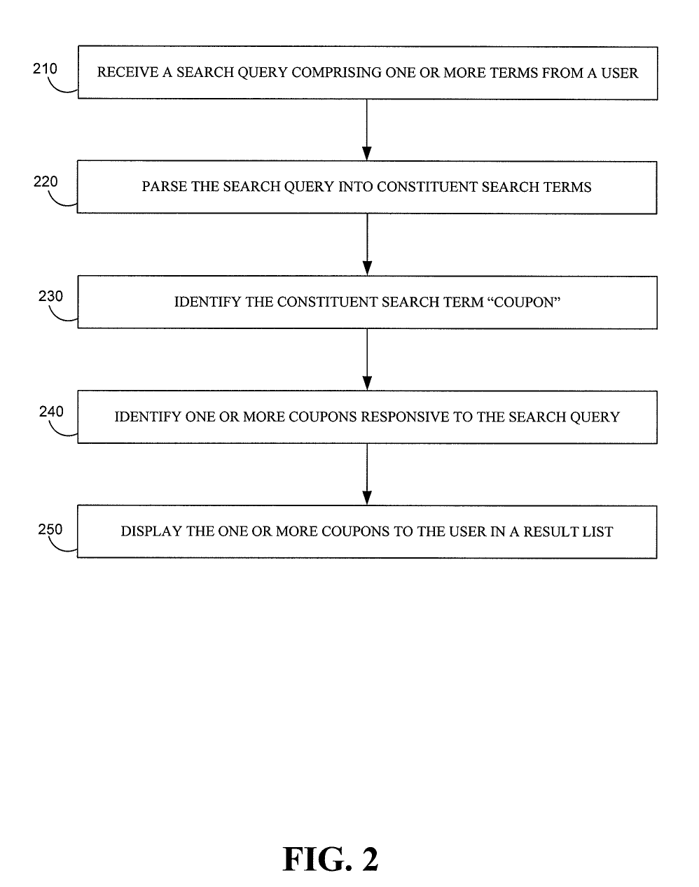

In another embodiment, upon making a determination that the search query contains a request for a coupon, the content manager may generate a search request based upon the parsed search query and transmit the search request to the search engine 150. The search engine 150 may then perform a search for a result set of coupons upon the content provider 120 via the computer network 120. Upon identifying one or more coupons responsive to the search query, the search engine 150 may then return a result set of the one or more coupons responsive to the search query over the computer network 120 to be displayed at the client device 110 to a user. Methods for displaying coupons directly within search results will be described in further detail below with respect to the description of FIGS. 2 through 5.

FIG. 2 illustrates a flow diagram presenting a method for displaying coupons directly within search results according to one embodiment of the present invention. In accordance with the embodiment of FIG. 2, the method may begin receiving a search query comprising one or more terms from a user, step 210. The search query may be then parsed into constituent terms, step 220. For example, a search provider may receive the search query “staples coupons”, which is parsed into the constituent terms “staples” and “coupon”. The constituent search term “coupon” is then identified, step 230. Continuing from the previous example, the constituent search term “coupon” in the parsed search, indicating that the search query is for a coupon. One or more coupons responsive to the search query are identified, step 240 and displayed to the user in a result set, step 250. As applied to the example, four printable coupons may be located and images of the coupons are presented to a user at his personal computer in the result set. According to one embodiment, the responsive result set of the coupon images may be presented to a user in a result set that encompasses solely coupon images. In another embodiment, the result set of coupon images may by presented to a the user in an integrated result list encompassing the coupon images as well as hypertext links to other related content material.

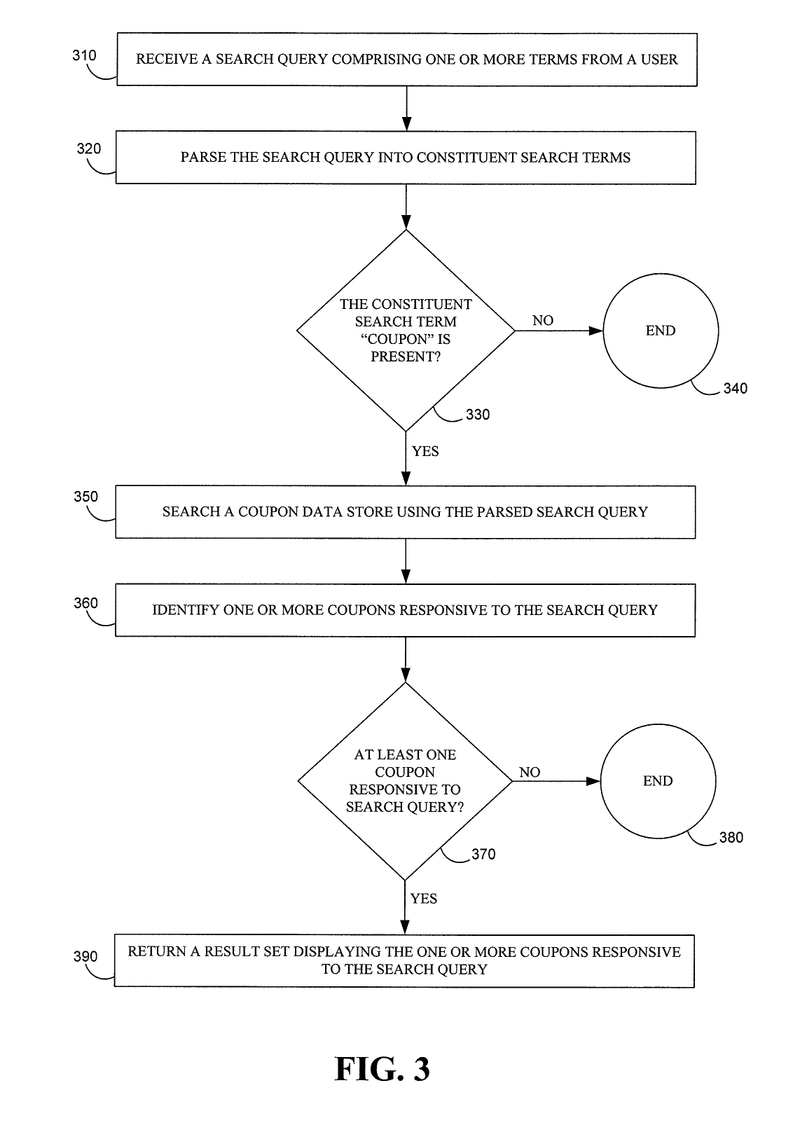

FIG. 3 illustrates a flow diagram presenting a method for searching a coupon index in order to display coupons directly within search results according to one embodiment of the present invention. In accordance with the embodiment of FIG. 3, the method may begin receiving a search query comprising one or more terms from a user, step 310. The search query may be then parsed into constituent terms, step 320. For example, a query parser, such as the query parser 160 of FIG. 1, may use an algorithm to parse the search query “staples coupons” into the constituent tokens, “staples” and “coupons”. The next step, step 330, includes determining if the constituent search term “coupon” is present. As discussed above with respect to FIG. 1, this may be performed by the content manager 170, wherein the content manager 170 may use certain matching rules to determine that the constituent search term “coupon” is present. If the search term “coupon” is absent, the flow of the method ends, step 340. If the search term “coupon” is present, the method continues and a coupon data store is searched using the parsed search query, step 350. Continuing from the previous example, an indexing component, such as the indexing component 180 of the system 100, may search the coupon data store 190 to locate one or more coupons related to the merchants, Staples.com® and Staples®, based upon the constituent search term “staples”. One or more coupons responsive to the search query may then be identified, step 360. A determination may be then made as to whether at least one coupon is responsive to the search query, step 370. If no coupons are located which are responsive to the search query, the flow will end, step 380. If at least one coupon responsive to search query is located, the method will continue and a result set is retuned displaying the one or more coupons responsive to the search query, step 390. Continuing from the previous example, an indexing component may locate four printable coupons for the merchant, Staples®, which are located in the index of a coupon data store, and the images of these coupons are displayed to a user in a result set by a content manager, such as the content manager 170 of the system 100, via a computer network.

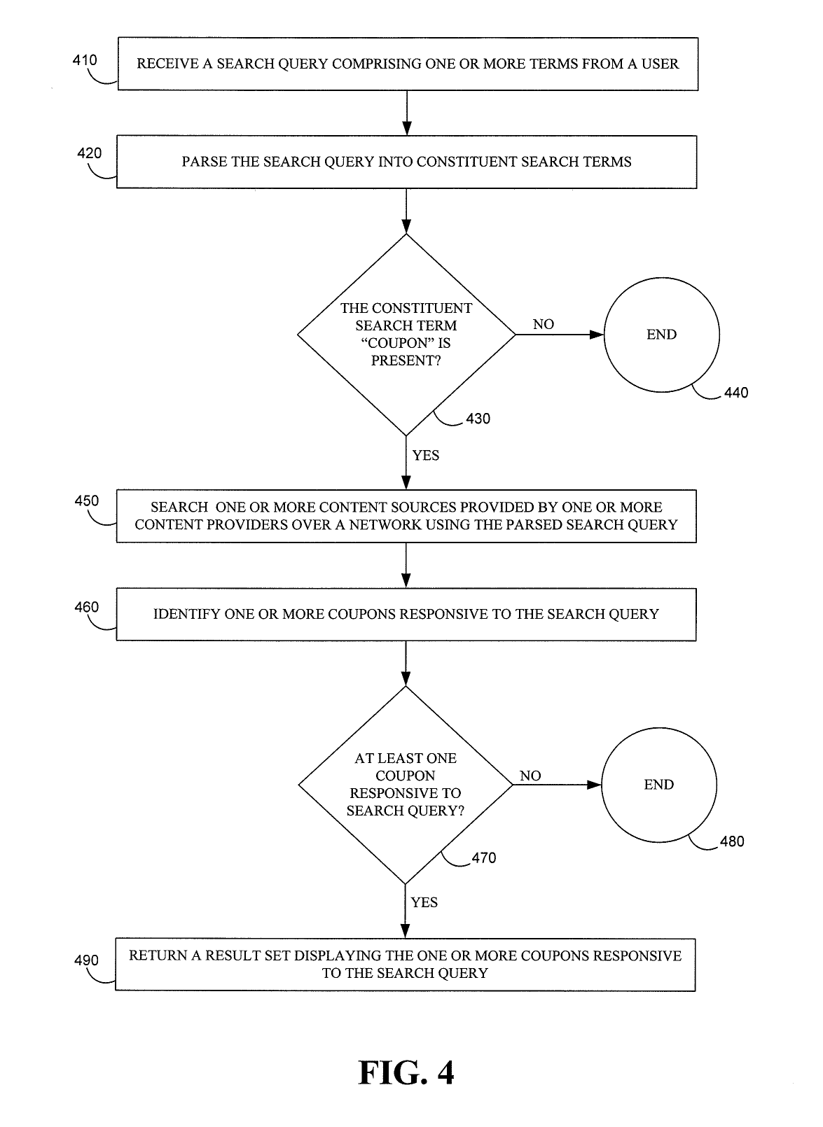

FIG. 4 illustrates a flow diagram presenting a method for searching content sources in order to display coupons directly within search results according to another embodiment of the present invention. In accordance with the embodiment of FIG. 4, the method may begin receiving a search query comprising one or more terms from a user, step 410. The search query may be then parsed into constituent terms, step 420. The next step, step 430, includes determining if the constituent search term “coupon” is present. If the search term “coupon” is absent, the flow of the method ends, step 440. If the search term “coupon” is present, the method continues and a search is performed of one or more content sources provided by one or more content providers over a network using the parsed search query, step 450. Continuing from the previous example, a search engine, such as the search engine 150 of the system 100, may search content provided by one or more content providers over a computer network, as is known in the art, to locate one or more coupons related to the merchants, Staples.com® and Staples®, based upon the constituent search term “staples”. One or more coupons responsive to the search query may then be identified, step 460. A determination may be then made as to whether at least one coupon is responsive to the search query, step 470. If no coupons are located which are responsive to the search query, the flow will end, step 480. If at least one coupon responsive to search query is located, the method will continue and a result set is retuned displaying the one or more coupons responsive to the search query, step 490. Continuing from the previous example, a search engine may locate four printable coupons for the merchant, Staples from a plurality of content sources and the images of these coupons are displayed to a user in a result set.

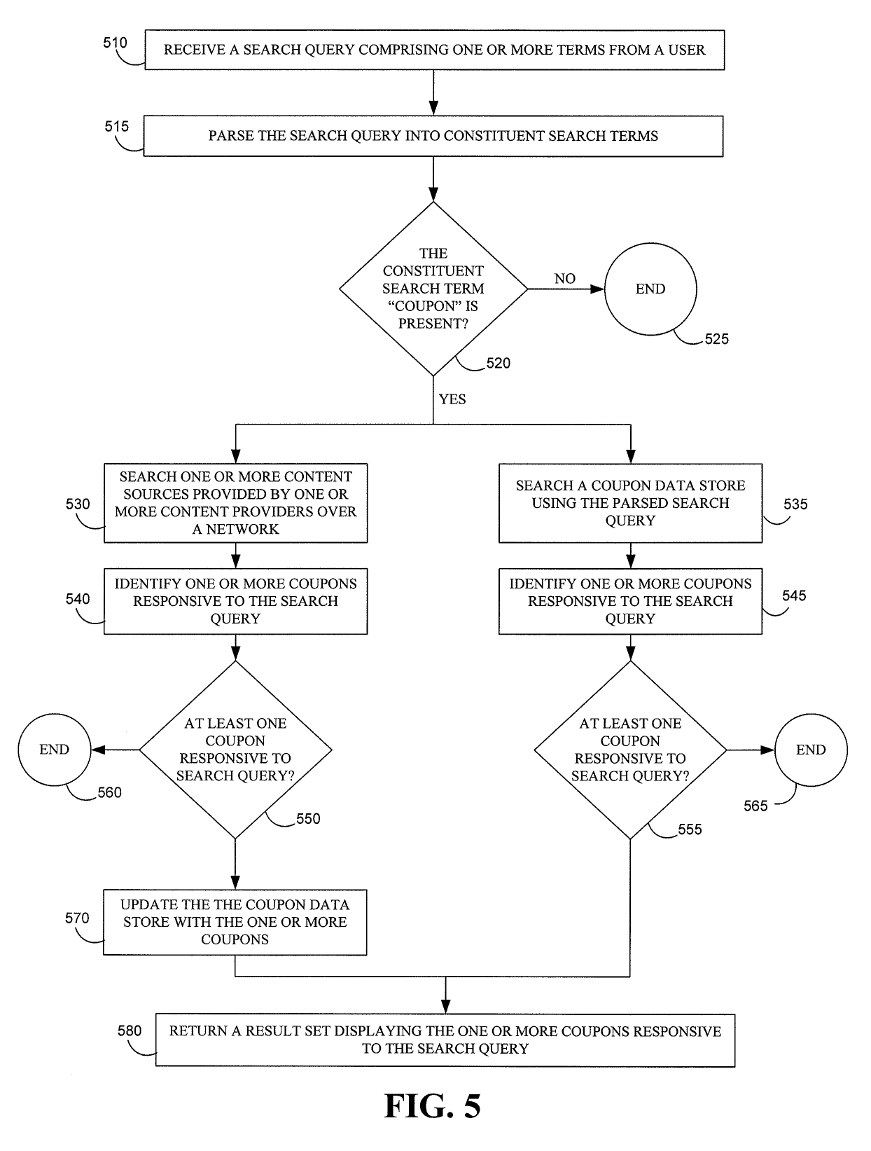

FIG. 5 illustrates a flow diagram presenting a method for searching content sources and a coupon index in order to display coupons directly within search results according to another embodiment of the present invention. In accordance with the embodiment of FIG. 5, the method may begin receiving a search query comprising one or more terms from a user, step 510. The search query may be then parsed into constituent terms, step 515. The next step, step 520, includes determining if the constituent search term “coupon” is present. If the search term “coupon” is absent, the flow of the method ends, step 525. If the search term “coupon” is present, the method continues and a search is performed of one or more content sources provided by one or more content providers over a network using the parsed search query, step 530. One or more coupons responsive to the search query may then be identified, step 540. A determination may be then made as to whether at least one coupon is responsive to the search query, step 550. If no coupons are located which are responsive to the search query, the flow will end, step 560. If at least one coupon responsive to search query is located, the method will continue and the coupon data store will be updated with the one or more coupons that have been located, step 570. Continuing from the previous example, four printable coupons for the merchant, Staples® are located from a plurality of content sources and added to the index of the coupon data store.

Simultaneously with the search performed of the one or more content sources initiated in step 530, a search is performed on a coupon index using the parsed search query, step 3535. One or more coupons responsive to the search query may then be identified, step 545 and a determination may be then made as to whether at least one coupon is responsive to the search query, step 555. If no coupons are located which are responsive to the search query, the flow will end, step 565. If at least one coupon responsive to search query is located, the method will continue to step 580. The final step, step 580, a result set is retuned displaying the one or more coupons responsive to the search query. Continuing from the previous example, a content manager may receive a total of eight coupons responsive to the search query, where two of the coupons are identical, from an indexing component, which located four of the coupons in the coupon data store, and from the search engine, which located four of the coupons from content sources on a computer network. The content manager may utilize certain matching rules to determine that two of the eight coupons it has received are identical. As a result, the content manager may return a result set of seven coupons for the merchant Staples®, resulting in seven coupon images displayed to a user in a result set.

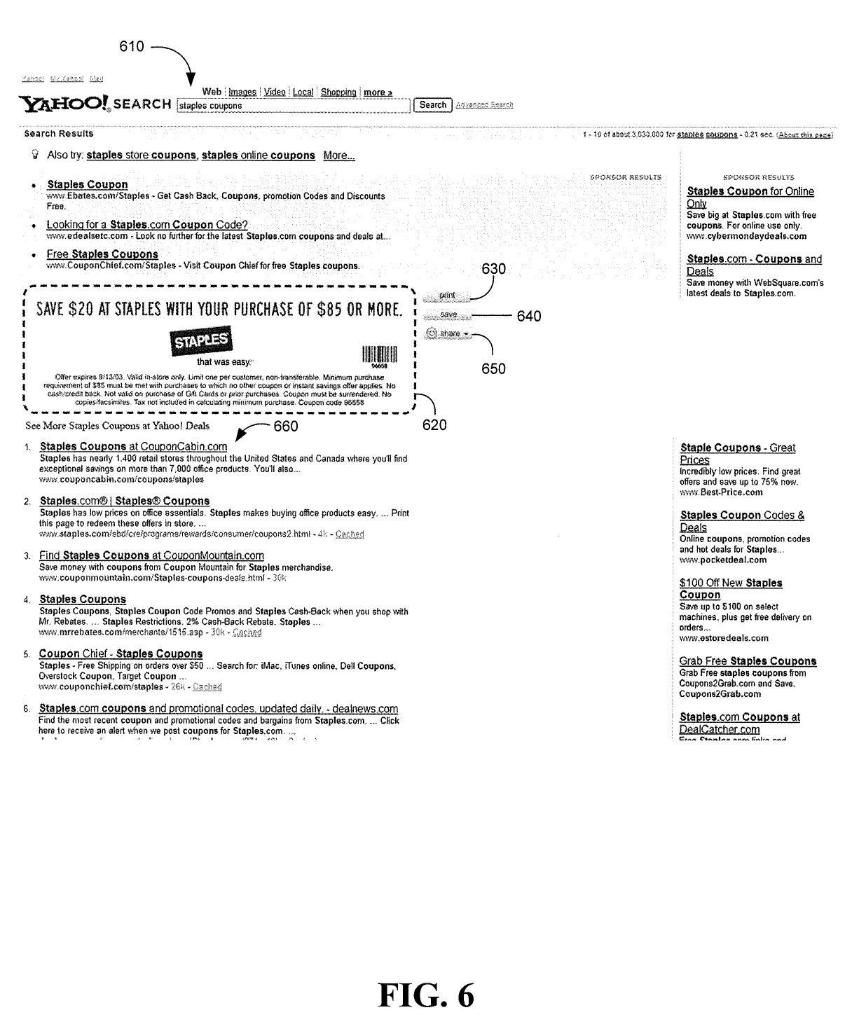

FIG. 6 illustrates a sample screen image of a result set which display coupon images directly within the result set according to one embodiment of the present invention. Continuing from the previous example, and as illustrated in FIG. 6, a user may enter the search query “staples coupons” into a field on a search provider's website, such as Yahoo.com, which is illustrated at 610. As previously described with respect to FIGS. 1 through 5, in response to the search query, a result set is generated and retuned to a user display one or more coupons responsive to the search query. For example, in response to the search query “staples coupons”, a coupon for the merchant Staples® may be located and displayed within a result set, as illustrated by at 620. According one embodiment, associated with the one or more coupons displayed within the result set are certain functions that may be performed using the one or more coupons. For example, the coupon for the merchant Staples® may have associated with a print function, a save function and a share function. As illustrated in FIG. 6, a print button 630, a save button 640 and a share button 650 are displayed with the coupon for the merchant Staples® within the result set. The print function may allow for the printing of the coupon for the merchant Staples®, such as to a local network printer; the save function may allow for the saving of the coupon, such as to a user computer local storage drive; and the share function may allow for the sharing of the coupon, such as the e-mailing or other forms of transmitting the coupon to one or more secondary users selected by the user. According to one embodiment, the one or more coupons are displayed within a result set, where the result set encompasses hypertext links to content sources on the Internet that may host coupons responsive to the search query, in addition to the one or more coupon images located by the method of the present invention. According to another embodiment, the one or more coupons are displayed within a result set, where the result set encompasses solely the one or more coupon images located by the method of the present invention.

In accordance with the foregoing description, the present invention provides for systems, methods and computer program products for the direct display of coupons within a search result set. In providing for the for the direct display of coupons within a search result set, the present invention allows for the solution to frustrated users to the common problem of hypertext links containing false leads by allowing the users to immediately see coupons responsive to their search query within the result set, saving users both frustration and time.

FIGS. 1 through 6 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for directly displaying coupons within a search result set, the method comprising:
receiving a search query comprising one or more terms from a user;
parsing the search query into one or more constituent terms;
identifying a predetermined constituent search term;
identifying one or more coupons responsive to the search query; and
displaying the one or more coupons to the user in a result set.

2. The method of claim 1, wherein identifying a predetermined constituent search term, further comprises identifying the predetermined constituent search term “coupon”.

3. The method of claim 1, wherein identifying one or more coupons responsive to the search query, further comprises searching a coupon data store using the parsed search query, wherein the coupon data store comprises an index of one or more coupons.

4. The method of claim 1, wherein identifying one or more coupons responsive to the search query, further comprises searching one or more content sources provided by one or more content providers over a network using the parsed search query.

5. The method of claim 1, wherein identifying one or more coupons responsive to the search query, further comprises:
searching a coupon data store using the parsed search query, wherein the coupon data store comprises an index of one or more coupons; and
searching one or more content sources provided by one or more content providers over a network using the parsed search query.

6. The method of claim 5, wherein identifying one or more coupons responsive to the search query, further comprises updating the data coupon store with the one or more coupons identified as a result of the search of one or more content sources provided by one or more content providers over a network using the parsed search query.

7. The method of claim 1, wherein displaying the one or more coupons to the user in a result set, further comprises displaying a print control allowing for the function of printing the one or more coupons displayed in the result set.

8. The method of claim 1, wherein displaying the one or more coupons to the user in a result set, further comprises displaying a save control allowing for the function of saving the one or more coupons displayed in the result set.

9. The method of claim 1, wherein displaying the one or more coupons to the user in a result set, further comprises displaying a share control allowing for the function of sharing the one or more coupons displayed in the result set.

10. Computer readable media comprising program code that when executed by a programmable causes execution of a method for directly displaying coupons within a search result set, the computer readable media comprising:
program code for receiving a search query comprising one or more terms from a user;
program code for parsing the search query into one or more constituent terms;
program code for identifying a predetermined constituent search term;
program code for identifying one or more coupons responsive to the search query; and
program code for displaying the one or more coupons to the user in a result set.

11. The computer readable media of claim 10, wherein program code for identifying a predetermined constituent search term, further comprises program code for identifying the predetermined constituent search term “coupon”.

12. The computer readable media of claim 10, wherein program code for identifying one or more coupons responsive to the search query, further comprises program code for searching a coupon data store using the parsed search query, wherein the coupon data store comprises an index of one or more coupons.

13. The computer readable media of claim 10, wherein program code for identifying one or more coupons responsive to the search query, further comprises program code for searching one or more content sources provided by one or more content providers over a network using the parsed search query.

14. The computer readable media of claim 10, wherein program code for identifying one or more coupons responsive to the search query, further comprises:
program code for searching a coupon data store using the parsed search query, wherein the coupon data store comprises an index of one or more coupons; and
program code for searching one or more content sources provided by one or more content providers over a network using the parsed search query.

15. The computer readable media of claim 14, wherein program code for identifying one or more coupons responsive to the search query, further comprises program code for updating the data coupon store with the one or more coupons identified as a result of the search of one or more content sources provided by one or more content providers over a network using the parsed search query.

16. The computer readable media of claim 10, wherein program code for displaying the one or more coupons to the user in a result set, further comprises program code for displaying a print control allowing for the function of printing the one or more coupons displayed in the result set.

17. The computer readable media of claim 10, wherein program code for displaying the one or more coupons to the user in a result set, further comprises program code for displaying a save control allowing for the function of saving the one or more coupons displayed in the result set.

18. The computer readable media of claim 10, wherein program code for displaying the one or more coupons to the user in a result set, further comprises program code for displaying a share control allowing for the function of sharing the one or more coupons displayed in the result set.

19. A system for directly displaying coupons within a search result set, the system comprising:
a computer network;
a search engine operative to receive a search query comprising one or more terms from a user;
a query parser operative to parse the search query into one or more constituent terms;
a content manager operative to,
identify a predetermined constituent search term, and
identify one or more coupons responsive to the search query; and
a client device operative display the one or more coupons to the user in a result set.

20. The system of claim 19, wherein the content manager is operative to identify the predetermined constituent search term “coupon”.

21. The system of claim 19, further comprising:
a coupon data store operative to store an index of one or more coupons; and
an indexing component operative to search the coupon data store using the parsed search query to identify one or more coupons responsive to the search query.

22. The system of claim 19, wherein the search engine is operative to search one or more content sources provided by one or more content providers over the computer network using the parsed search query to identify one or more coupons responsive to the search query.

23. The system of claim 19, further comprising:
a coupon data store operative to store an index of one or more coupons;
an indexing component operative to search the coupon data store using the parsed search query to identify one or more coupons responsive to the search query; and
the search engine operative to search one or more content sources provided by one or more content providers over the computer network using the parsed search query to identify one or more coupons responsive to the search query.

24. The system of claim 19, wherein the content manager is operative to update the data coupon store with the one or more coupons identified as a result of the search of one or more content sources provided by one or more content providers over the computer network using the parsed search query.

25. The system of claim 19, wherein the client device is operative to display a print control allowing for the function of printing the one or more coupons displayed in the result set.

26. The system of claim 19, wherein the client device is operative to display a save control allowing for the function of saving the one or more coupons displayed in the result set.

27. The system of claim 19, wherein the client device is operative to display a share control allowing for the function of sharing the one or more coupons displayed in the result set.
